(19) United States
(12) Patent Application Publication
(10) Pub. No.: US 2016/0018043 A1
(43) Pub. Date: Jan. 21, 2016

(54) SYSTEM AND METHOD FOR REPAIR AND MAINTENANCE OF PIPELINES

(71) Applicant: Edward Thomas Richards, Jr., Folsom, CA (US)

(72) Inventor: Edward Thomas Richards, Jr., Folsom, CA (US)

(21) Appl. No.: 14/872,915

(22) Filed: Oct. 1, 2015

Related U.S. Application Data
(63) Continuation-in-part of application No. 14/142,499, filed on Dec. 27, 2013.
(60) Provisional application No. 62/058,988, filed on Oct. 2, 2014.

(51) Int. Cl. F16L 55/1645; F16L 55/18

(52) U.S. Cl. CPC F16L 55/1645; F16L 55/18

(57) ABSTRACT

Systems and methods for the repair and maintenance of pipelines are disclosed. An example embodiment includes a pipeline maintenance apparatus comprising: a skid for insertion into a pipe, the skid being fabricated from a low-friction material, the skid being configured with sloped or angled ends; a plumber's snake being removably connected to a rear or trailing end of the skid; and a camera being removably encased in the forward end of the skid.

### PRIORITY PATENT APPLICATIONS

This is a non-provisional patent application claiming priority to co-pending U.S. provisional patent application, Ser. No. 62/058,988; filed Oct. 2, 2014 by the same applicant as the present application. This present patent application is also a continuation-in-part patent application claiming priority to co-pending U.S. patent application Ser. No. 14/142,499; filed Dec. 27, 2013 by the same applicant as the present application. This present patent application draws priority from the referenced patent applications. The entire disclosure of the referenced patent applications is considered part of the disclosure of the present application and is hereby incorporated by reference herein in its entirety.

### TECHNICAL FIELD

The disclosed subject matter relates to the field of pipes, pipelines, venting, ducting, conduit, and other passageway technology, and particularly to the repair and maintenance of pipelines.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2012-2015, Edward Thomas Richards, Jr., All Rights Reserved.

### BACKGROUND

Conventional technologies provide numerous systems and methods to repair and maintain pipelines, conduits, and passageways from the inside in order to restore the integrity of these pipeline systems. It is often necessary to perform in situ rehabilitation of these pipeline systems; because, the surrounding infrastructure may not permit a sufficient level of access. Some conventional pipe repair systems use a fabric liner impregnated with a resin and inserted into a pipe. However, the fabric liner can be expensive and difficult to install. Some pipe repair systems or pipeline pigs use devices with wheels, tracks, or rails. However, the wheels, tracks, or rails can get stuck in ruts or irregular areas in the interior of the pipe. Other pipe repair systems are designed to only be pulled through a pipe. However, it is not always possible to get access to the interior of a pipe from an end of the pipeline where these devices must be pulled. Still other pipeline repair systems are designed for large diameter or straight pipe segments. These systems cannot support small diameter pipelines with turns, angles, and curves. Still other pipeline repair systems use a robotic device configured to move at a constant rate through the pipeline. These systems cannot slow or stop the pace of the device if a particular portion of the pipeline may need special care.

### BRIEF DESCRIPTION OF THE DRAWINGS

Embodiments are illustrated by way of example and not limitation in the figures of the accompanying drawings, in which:

FIGS. 1 and 2 illustrate an example embodiment of the pipeline maintenance apparatus of an example embodiment;

FIGS. 3 and 4 illustrate a detail of a head end or forward end of the skid of the pipeline maintenance apparatus of the example embodiment;

FIGS. 5 and 6 illustrate a first alternative embodiment of the pipeline maintenance apparatus with light openings on the head end or forward end of the skid;

FIGS. 7 and 8 illustrate a detail of a head end or forward end of the skid of the pipeline maintenance apparatus of the first alternative embodiment;

FIGS. 9 and 10 illustrate a second alternative embodiment of the pipeline maintenance apparatus including a side opening; and

FIG. 11 illustrates a detail of a head end or forward end of the skid of the pipeline maintenance apparatus of the second alternative embodiment.

### DETAILED DESCRIPTION

In the following detailed description, reference is made to the accompanying drawings that form a part hereof, and in which are shown, by way of illustration, specific embodiments in which the disclosed subject matter can be practiced. It is understood that other embodiments may be utilized and structural changes may be made without departing from the scope of the disclosed subject matter.

According to various example embodiments of the disclosed subject matter as described herein, there are described and claimed systems and methods for the repair and maintenance of pipelines. In the various embodiments described herein the pipe or pipeline as denoted herein can include conventional pipes, piping, or pipelines, venting, ducting, conduit, and/or other tubular or rectangular hollow passageway fabricated from a variety of materials including metal, polyvinyl chloride (PVC) or other plastics, composite materials, ceramic, fiberglass, or concrete. In an example embodiment, the pipeline maintenance apparatus as described herein can operate in pipes of a diameter from two inches to several feet. The example embodiments provide a system and method for in situ maintenance and repair of various types and sizes of pipes and pipeline systems. The example embodiments can be used in pipeline arrangements with bends, turns, angles, curves, or reduced diameter segments. The example embodiments are designed to be pushed or pulled through a pipe instead of only being pulled. A skid enables the apparatus to move through a pipe without wheels, tracks, or rails. Some embodiments also provide a video camera at the forward end of the apparatus to enable a user to view the inside of the pipe while the apparatus is in operation. A detailed description of various example embodiments of the system and apparatus is provided below.

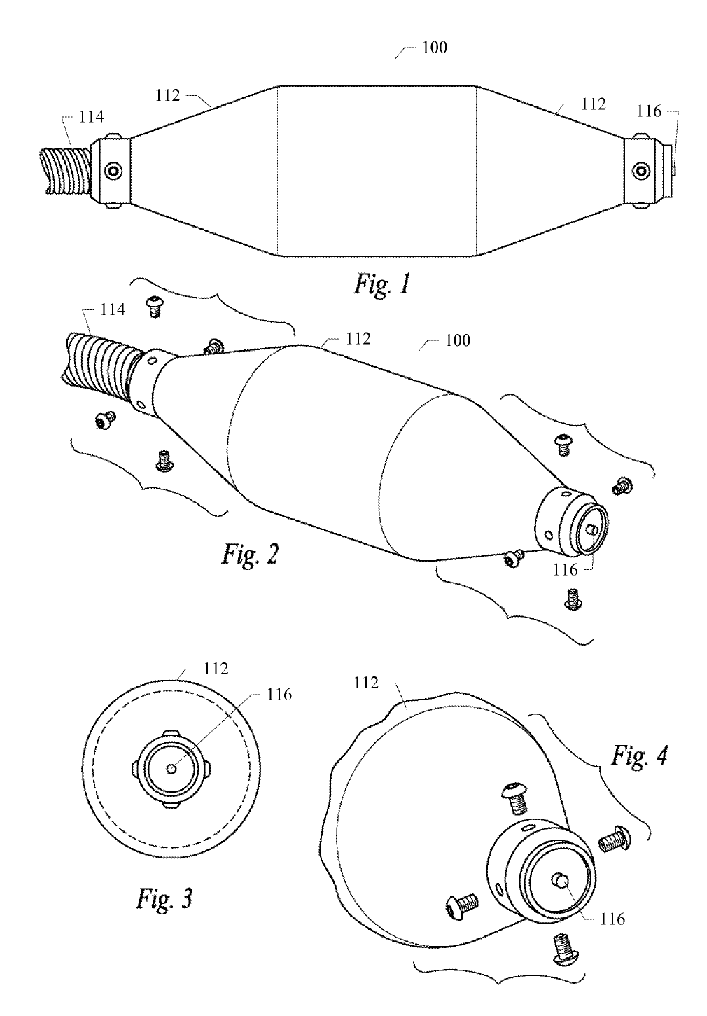

Referring now to FIGS. 1 and 2, an example embodiment of a pipeline maintenance apparatus 100 is illustrated. The pipeline maintenance apparatus 100 of an example embodiment comprises a skid 112. The skid 112 can be fabricated from a low-friction material, such as polyethylene, polytetrafluoroethylene (PTFE), high-density polyethylene (HDPE), polyethylene high-density (PEHD), plastics, composites, metal, aluminum, or other low-friction materials. The skid 112 can be fabricated as a hollow cylindrical shape in the middle with sloped or angled ends as shown in FIGS. 1 and 2. The skid 112 can be fabricated as a single hollow shape or as two halves of a hollow shape. The skid 112 can be fabricated with a dimension of the skid 112 at the middle being larger than dimensions of the skid 112 at the ends of the skid 112. The hollow shape of the skid 112 can be fabricated using well-known injection molding techniques. The sloped ends of the skid 112 enable the skid 112 to maneuver through a pipe that may have obstructions, uneven portions, ruts, or rusted, rotted, broken, or split portions. The skid 112 of an example embodiment can maneuver through a pipe that would stall a conventional wheeled or railed pipe repair system. The skid 112 of an example embodiment can also maneuver through pipeline arrangements with bends, turns, angles, curves, or reduced diameter segments.

As shown in FIGS. 1 and 2, the skid 112 of an example embodiment can be removably connected to a plumber's snake 114 or other flexible mechanism to provide a pushing or pulling force to the skid 112. The snake 114 can be removably connected to a rear or trailing end of the skid 112 using screws, bolts, or pins as shown in FIGS. 1 and 2.

FIGS. 3 and 4 illustrate a detail of the head end or forward end of the skid 112 of the pipeline maintenance apparatus 100 of the example embodiment. As shown, the forward end of the skid 112 includes a video camera 116. The video camera 116 is encased by the forward end of the skid 112 as shown in FIGS. 3 and 4. The video camera 116 can be removably encased in the forward end of the skid 112 using screws, bolts, or pins as shown in FIGS. 3 and 4. The video camera 116 can be a standard type of camera. In one embodiment, a camera used can be identified as a Lawmate, model—#CMSS42. By virtue of the sloped forward end of the skid 112 in which the video camera 116 is encased, the video camera 116 is always positioned in a middle portion of the pipe through which the pipeline maintenance apparatus 100 is maneuvered. As a result, the video camera 116 is less likely to be mired in material or clutter within the pipe.

The camera 116 can include an adjustable intensity light at the lens of the camera 116 to illuminate the region ahead of the pipeline maintenance apparatus 100. The intensity of the camera light can be adjusted using a camera wire extending from the rear end of the video camera 116 and connecting to the snake 114. The camera wire can also serve to transfer still image data or video image data from the camera 116 to a recorder or rendering device outside of the pipe.

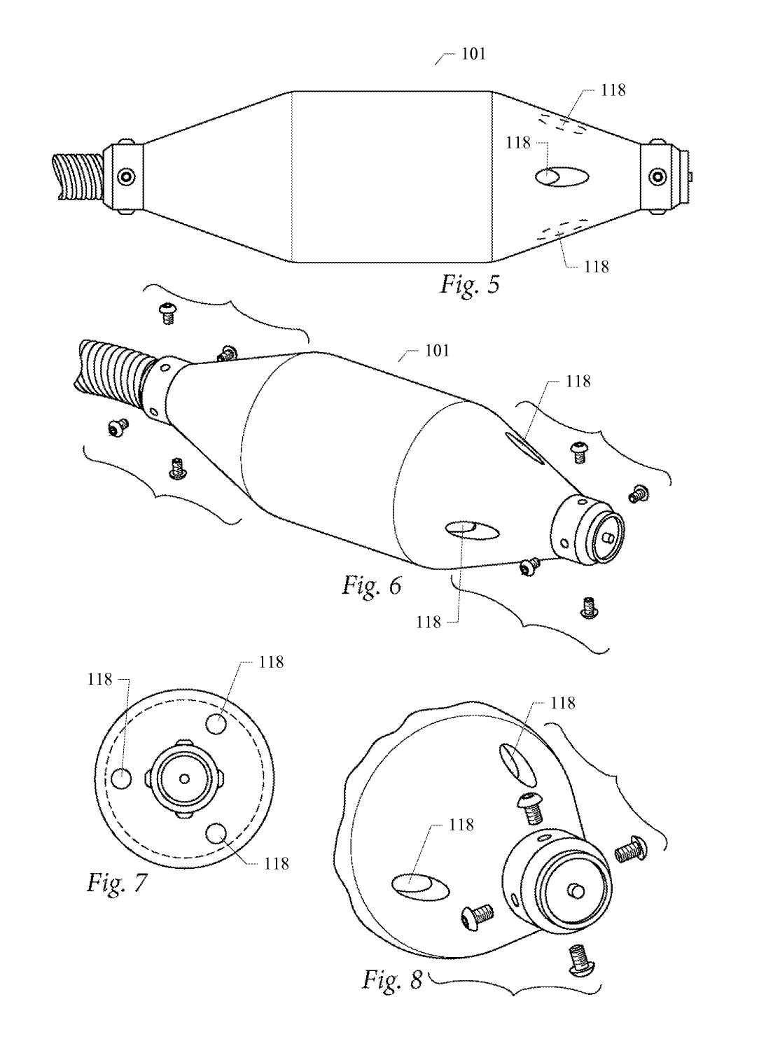

FIGS. 5 and 6 illustrate a first alternative embodiment 101 of the pipeline maintenance apparatus with light openings on the head end or forward end of the skid. In applications where more light ahead of the skid 112 is needed to illuminate the pipe, light openings 118 are provided in the forward end of the skid 112. The light openings 118 can enable the installation of multiple light sources within the interior of skid 112. The light produced by the light sources can be configured to emit light beams out of the light openings 118 and toward the area of a pipe ahead of the skid 112. The light sources can be battery operated flashlights or light emitting diode light sources. In the first alternative embodiment shown in FIGS. 5 through 8, three light openings 118 are provided for three light sources. It will be apparent to those of ordinary skill in the art that a greater or lesser number of light openings can be used.

FIGS. 7 and 8 illustrate a detail of a head end or forward end of the skid of the pipeline maintenance apparatus of the first alternative embodiment. As shown, light openings 118 are provided in the forward end of the skid 112 to illuminate the area of a pipe ahead of the skid 112. In this manner, the images captured by the video camera 116 can be better quality images.

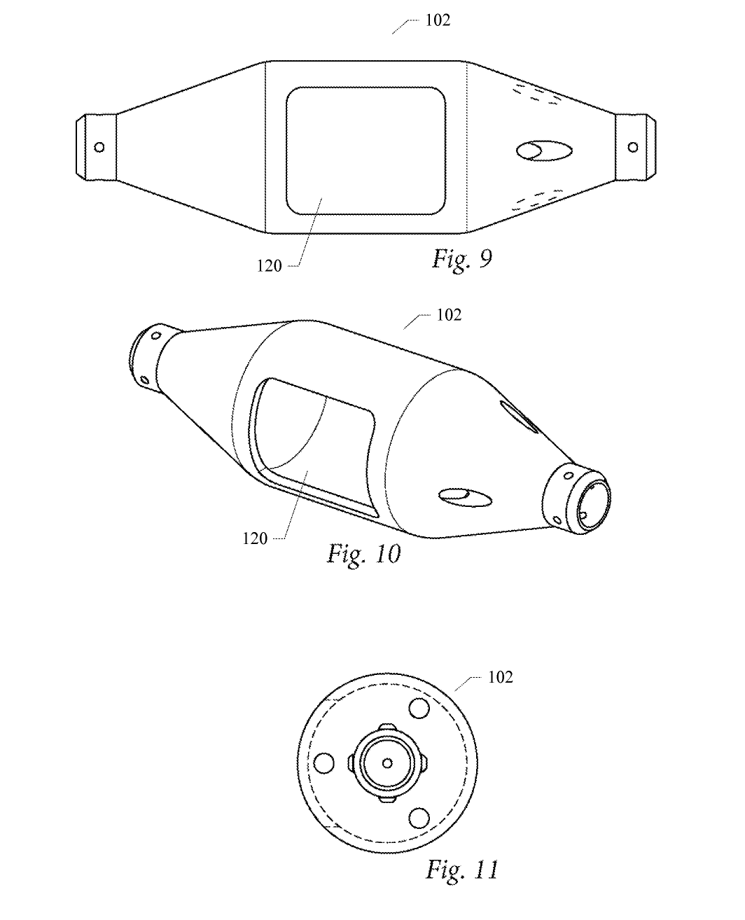

FIGS. 9 and 10 illustrate a second alternative embodiment 102 of the pipeline maintenance apparatus including a side opening 120. In a particular embodiment, the interior of the skid 112 can be exposed by cutting out a portion of the skid 112 to produce side opening 120. As a result, fill material, such as gravel, sand, or uncured concrete can be inserted into the side opening 120 to fill the interior of the skid 112 prior the insertion of the pipeline maintenance apparatus 100 into a pipe. The pipeline maintenance apparatus 100, including the fill material in the interior of skid 112 can be maneuvered to a desired location within the pipe. The video camera 116 can be used to assist the operator in positioning the skid 112 at the desired location. Then, the snake 114 can be used to turn the skid 112 within the pipe so the side opening 120 is placed with the opening in a downward position. As a result, gravity serves to empty the contents of the skid 112 at the desired location in the pipe. In this manner, the fill material can be carried to a desired location within a pipe via the skid 112 and dumped at the desired location using the side opening 120. As shown in FIGS. 9 and 10, the side opening 120 can expose the interior cavity of skid 112 and enable the fill material to dump when the skid 112 is rotated.

FIG. 11 illustrates a detail of a head end or forward end of the skid of the pipeline maintenance apparatus 102 of the second alternative embodiment. As described above, a forward end of the skid 112 can include a video camera 116. Light openings 118 can also be provided in the forward end of the skid 112. The camera 116 and the light openings 118 can assist the operator in positioning the skid 112 at the desired location. Then, the fill material can be dumped at the desired location within the pipe using the side opening 120.

As disclosed herein in various example embodiments, the pipeline maintenance apparatus is pushable or pullable through a pipe using the plumber's snake 114. The pipeline maintenance apparatus of an example embodiment is also pushable or pullable through a pipe of a dimension in the range of two inches to three feet. The pipeline maintenance apparatus of an example embodiment is also pushable or pullable through a hollow passageway of a type from the group consisting of: a pipe, a pipeline, a vent, a duct, a conduit, a tubular hollow passageway, and a rectangular hollow passageway. The pipeline maintenance apparatus of an example embodiment is also pushable or pullable through a hollow passageway fabricated of material from the group consisting of: metal, polyvinyl chloride (PVC), plastic, composite material, ceramic, fiberglass, and concrete. The pipeline maintenance apparatus of an example embodiment is also pushable or pullable through a hollow passageway with bends, turns, angles, curves, or reduced diameter segments.

The illustrations of embodiments described herein are intended to provide a general understanding of the structure of various embodiments, and they are not intended to serve as a complete description of all the elements and features of components and systems that might make use of the structures described herein. Many other embodiments will be apparent to those of ordinary skill in the art upon reviewing the description provided herein. Other embodiments may be utilized and derived, such that structural and logical substitutions and changes may be made without departing from the scope of this disclosure. The figures herein are merely representational and may not be drawn to scale. Certain proportions thereof may be exaggerated, while others may be minimized. Accordingly, the specification and drawings are to be regarded in an illustrative rather than a restrictive sense.

The description herein may include terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus, the following claims are hereby incorporated into the Detailed Description, with each claim standing on its own as a separate embodiment.

As described herein, systems and methods for the repair and maintenance of pipelines are disclosed. Although the disclosed subject matter has been described with reference to several example embodiments, it may be understood that the words that have been used are words of description and illustration, rather than words of limitation. Changes may be made within the purview of the appended claims, as presently stated and as amended, without departing from the scope and spirit of the disclosed subject matter in all its aspects. Although the disclosed subject matter has been described with reference to particular means, materials, and embodiments, the disclosed subject matter is not intended to be limited to the particulars disclosed; rather, the subject matter extends to all functionally equivalent structures, methods, and uses such as are within the scope of the appended claims.

What is claimed is:

1. A pipeline maintenance apparatus comprising:
a skid for insertion into a pipe, the skid being fabricated from a low-friction material, the skid being configured with sloped or angled ends;
a plumber's snake being removably connected to a rear or trailing end of the skid; and
a camera being removably encased in the forward end of the skid.

2. The pipeline maintenance apparatus of claim 1 wherein the low-friction material is polyethylene.

3. The pipeline maintenance apparatus of claim 1 further including light openings positioned at the forward end of the body.

4. The pipeline maintenance apparatus of claim 1 wherein the skid is fabricated with a dimension of the skid at the middle being larger than dimensions of the skid at the ends of the skid.

5. The pipeline maintenance apparatus of claim 1 wherein the pipeline maintenance apparatus being pushable or pullable through a pipe using the plumber's snake.

6. The pipeline maintenance apparatus of claim 1 wherein the pipeline maintenance apparatus being pushable or pullable through a pipe of a dimension in the range of two inches to three feet.

7. The pipeline maintenance apparatus of claim 1 wherein the pipeline maintenance apparatus being pushable or pullable through a hollow passageway of a type from the group consisting of: a pipe, a pipeline, a vent, a duct, a conduit, a tubular hollow passageway, and a rectangular hollow passageway.

8. The pipeline maintenance apparatus of claim 1 wherein the pipeline maintenance apparatus being pushable or pullable through a hollow passageway fabricated of material from the group consisting of: metal, polyvinyl chloride (PVC), plastic, composite material, ceramic, fiberglass, and concrete.

9. The pipeline maintenance apparatus of claim 1 wherein the pipeline maintenance apparatus being pushable or pullable through a hollow passageway with bends, turns, angles, curves, or reduced diameter segments.

10. The pipeline maintenance apparatus of claim 1 wherein the skid includes a side opening configured to enable fill material to be dumped at a desired location within a pipe.
